(19) United States
(12) Patent Application Publication
(10) Pub. No.: US 2012/0187029 A1
(43) Pub. Date: Jul. 26, 2012

(54) POOL SKIMMER INTAKE WITH ELECTRONIC ACCESSORIES

(76) Inventors: Ken LAURO, Mahopac, NY (US); Richard MAIARO, Mount Vernon, NY (US)

(21) Appl. No.: 13/354,500

(22) Filed: Jan. 20, 2012

Related U.S. Application Data
(60) Provisional application No. 61/434,525, filed on Jan. 20, 2011.

(51) Int. Cl. E04H 4/16; C02F 1/00

(52) U.S. Cl. 210/85; 210/167.1; 210/167.19

(57) ABSTRACT

A pool skimmer inlet is sized and shaped to replace a standard pool skimmer plate. The skimmer inlet includes a replacement plate adapted to replace the standard filter plate and a body attached to the replacement plate. The body is formed with at least one cavity housing a sensor for monitoring pool conditions and an electronic sensor monitoring said sensor and generating appropriate electronic signals. Indicators may be mounted on the body together with one or more meshes that prefilter the water before it flows to a main filter.

### RELATED APPLICATIONS

This application claims priority to U.S. Provisional application Ser. No. 61/434,525 filed Jan. 20, 2011 and incorporated herein by reference.

### BACKGROUND OF THE INVENTION

a. Field of Invention

This invention pertains to a pool skimmer intake and more particularly to a cover for a pool skimmer intake that can be easily installed and removed and that includes sensors for a pool alarm.

b. Background of the Invention

Reference is first made to FIG. 1 showing an isometric view of an existing pool installation. In this installation, a pool has a sidewall 10 with a filter intake 12 defined by a front plate 14. Water from the pool flows through skimmer intake 12 through a main filter and a pump (not shown) disposed at a remote location. The filtered water is then returned to the pool by the pump through an inlet pipe (not shown).

It has been found that in general as the water circulates through the skimmer, bugs, leaves and other matter tend to migrate slowly toward the edges of the pool and then along the edges until they enter the intake 12, as indicated by arrows A, B.

### SUMMARY OF THE INVENTION

A pool skimmer intake constructed in accordance with this invention includes a face plate sized and shaped to replace an existing face plate in a pool; and a body having a back face formed with mounting elements for mounting said body on said face plate, an internal cavity housing sensors sensing conditions in the pool. The face plate and the body have matching openings defining a channel for fluid flow.

One of the face place and the body includes a rib and the other includes a channel sized and shaped to support said body on said face plate.

Preferably the rib and channel form an interference fit, such as a dovetail.

Preferably the body includes a front face, with indicators on said front face, such as one or more lights, or an audible alarm for indicating various conditions.

The body is formed with internal cavities for housing one or more sensors, such as a water level sensor, and a splash sensing when 10 LBS or more falls into the pool.

In addition, one or more meshes are pivotably attached to the body and arranged to prefilter the water before it flows to the main filter.

### BRIEF DESCRIPTION OF THE DRAWINGS

FIG. 1 shows a perspective view of a known pool skimmer inlet;

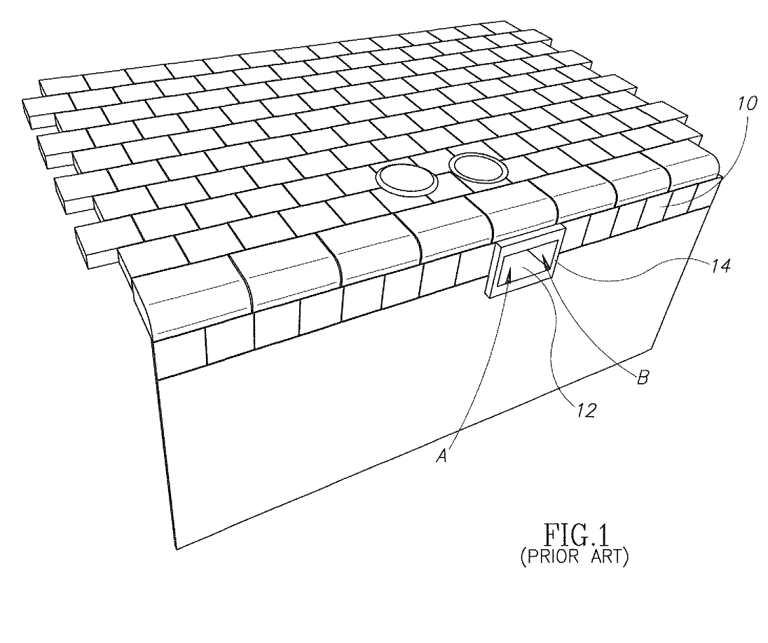

FIG. 2 shows a back view of a pool skimmer inlet plate in accordance with this invention;

FIG. 2A shows a side sectional view of the plate of FIG. 2;

FIGS. 3 and 4 show a bottom and a front view of the skimmer intake, respectively;

FIG. 5 shows a front view of the skimmer intake with the meshes installed; and

FIGS. 6 show front and side views, respectively, of a wire used to support a mesh forming a prefilter.

### DETAILED DESCRIPTION OF THE INVENTION

The present invention provides a skimmer intake that replaces the intake 12. The skimmer intake provides three functions. First, it includes two lateral meshes that are arranged so that they capture the foreign materials in the stream along arrows A and B. These meshes, therefore provide a pre-filter function. They can be easily removed and cleaned straight from the sidewall 10 and therefore regular maintenance through the access hole needs to be performed only rarely.

Second, the skimmer intake includes an integral pool alarm. The purpose of the pool alarm is to provide an audible and visual indication when a person or pet falls into the pool inadvertently. There are many such electronic devices presently available on the market that are normally are mounted on a floating platform and left on the pool's surface. The present invention uses the same electronic mechanisms but places them within the sidewall 10 where they are safer, stay cleaner, last longer and are out of the way so that children will not play, trip over or tamper with them.

Third, a separate electronic package is included in the filter intake that monitors the water level in the pool. if the water level falls below a certain threshold, the electronic package turns the pump off and therefore insures that the pump will not run idle and burn out.

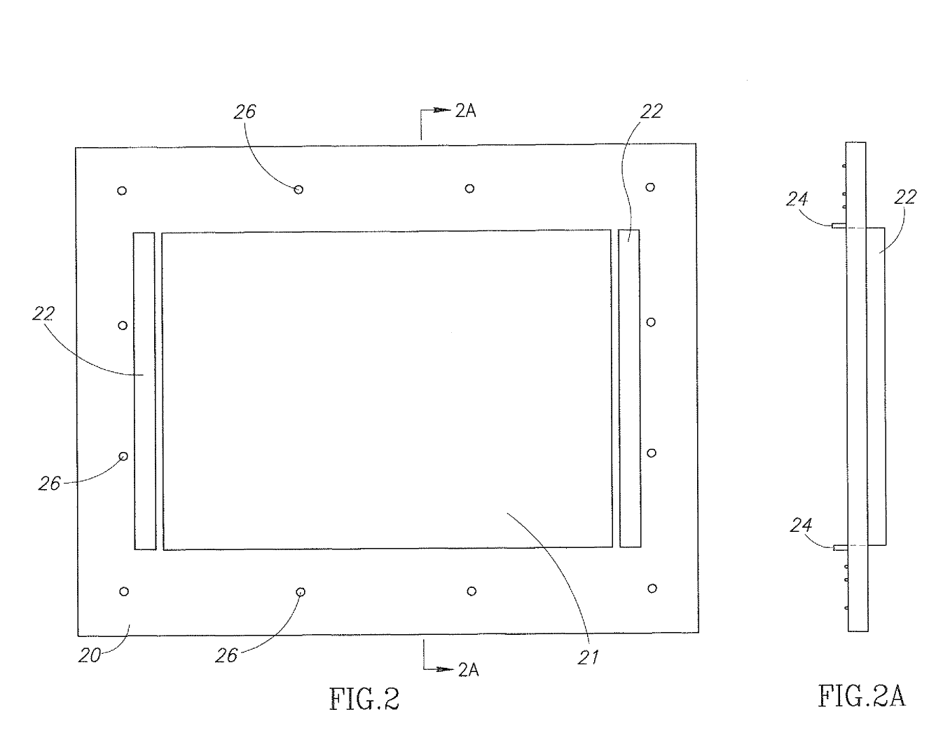

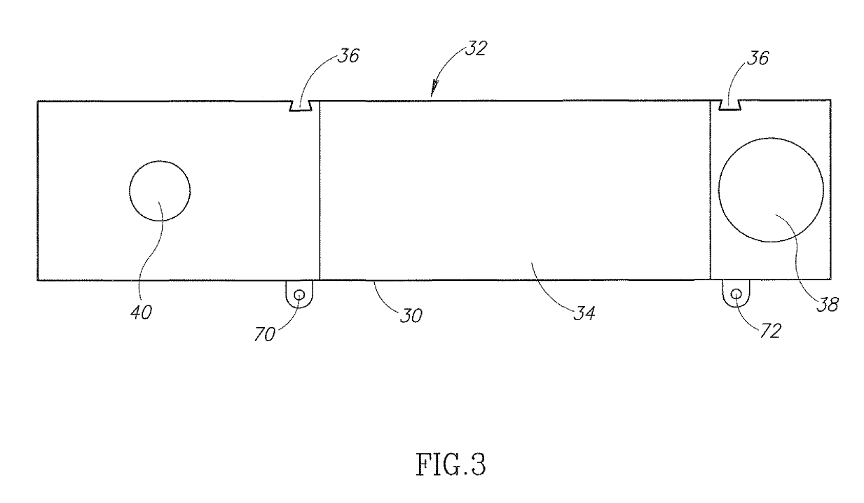

Advantageously, the inventive skimmer intake is shown in FIGS. 2-7 and it includes a new front plate 20. This new front plate 20 includes a central rectangular opening 21 and two vertical ribs 22 having a dovetail cross-section for mounting plate 20. As seen in FIG. 2A, the plate includes a thin rectangular rib 24 extending around the opening 21. On its top portion, plate 20 includes a plurality of holes 26. The plate 20 and the holes 26 are sized and shaped top allow a user to take off plate 14 from an existing filter inlet and replace it with plate 20.

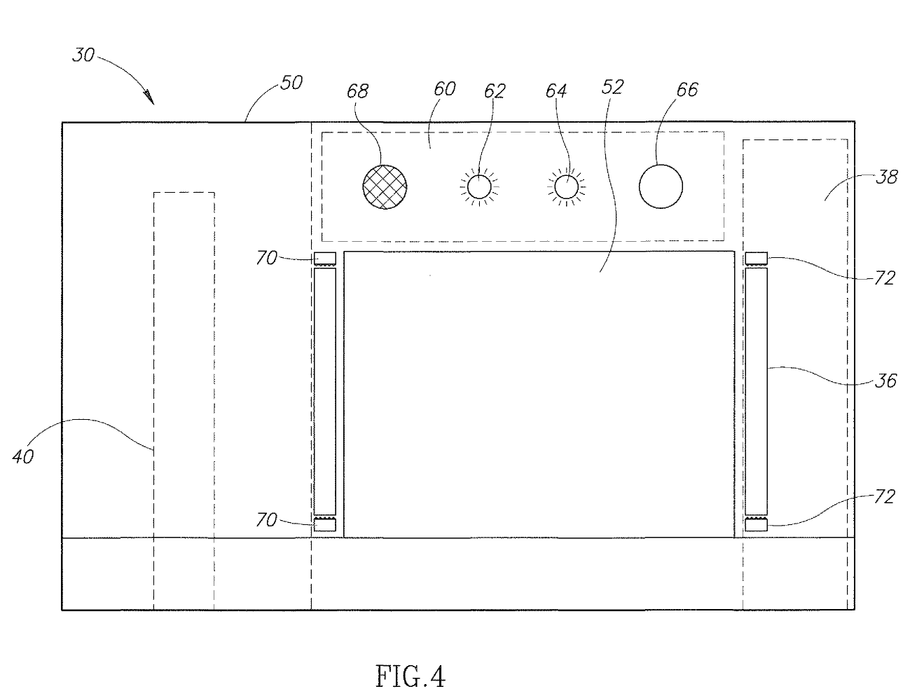

The intake further includes a main body 30 having a rear face 32, a bottom face 34, and a front face 50 as seen in FIGS. 3, 4 and 5. The rear face 32 is provided with two channels 36 receiving and forming an interference fit with the ribs 22 for mounting the face place 20. For this purpose the cross-section of channels 36 is complementary to the cross-section of ribs 22.

Also provided on the bottom face 34 are two cavities 38 and 40. Cavity 38 may be used to house a conventional water level sensor (not shown) and cavity 38 is used to hold a conventional splash sensor (not shown) sensing when an object 10 LBS or more falls into the pool.

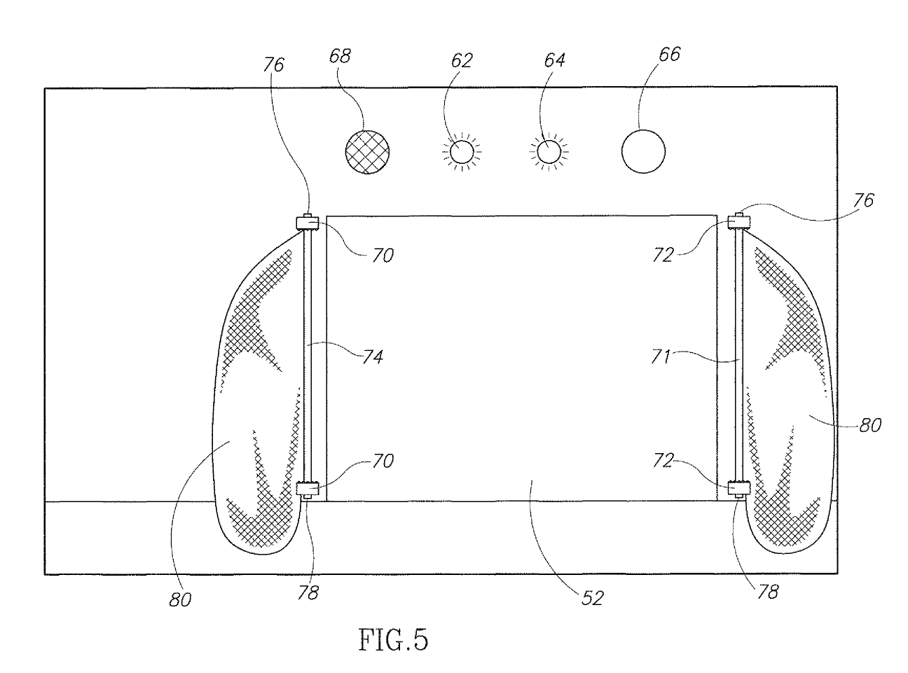

As shown in FIGS. 4 and 5, the front face 50 of body 30 includes a large rectangular opening 52. When the body 30 is installed on plate 20, this opening 52 lines up with opening 21 and forms the channel through which water from the pool flows to the main filter.

Body 30 is formed with an internal cavity 60 that is preferably water tight and includes conventional electronic circuitry and a battery. The electronic circuitry monitors the sensors in cavities 38 and 40 and activates indication lights 62, 64 to show the status of the circuit. For example, when everything is normal, light 62 may be activated. When an alarm condition (e.g, low water level, or a person falling in the pull) is sensed, then the light 64 can be sensed. Under certain conditions (e.g., when a person falls in the pool), an audio alarm 68 may be activated as well. The circuitry can be reset via pushbutton 66. All these indications and controls are readily available from on the front face 50 of body 30.

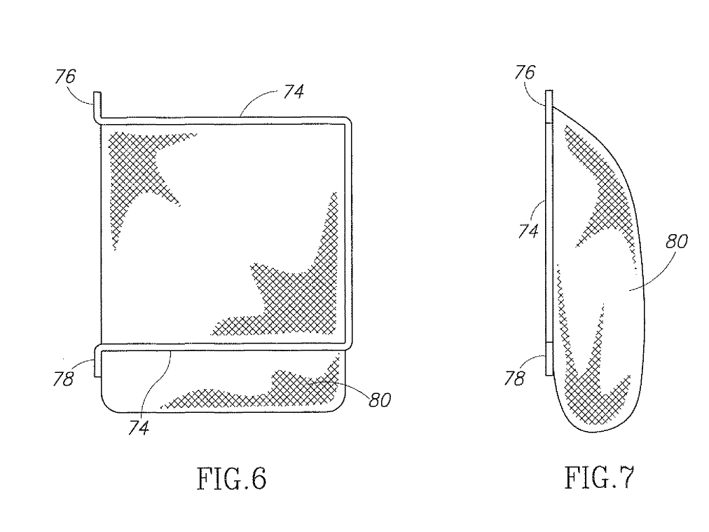

In addition, as seen in FIG. 4, the front face 50 is provided with two sets of loops 70. 72. Two frames 74 shown in FIGS. 6 and 7 are shaped to form a rectangular frame with ends 76, 78, respectively. A plastic mesh 80 is installed on each of the frames. The meshes 80 are somewhat loose to from pockets as seen in FIG. 7. The two frames are attached to the loops 70, 72, as shown in Fig. These are the meshes that act as prefilters for debris in the water. The meshes are shaped to form respective left and right screens. The frames 74 are somewhat flexible to form spring hinges with the loops 70, 72 and allow the meshes to be positioned as desired up to 180 degrees with respect to the vertical axes defined by the loops 70, 72. The prefilters thus formed can be installed and removed easily.

To summarize, the present invention provides an exquisite, permanent skimmer intake that includes in a single, easy to clean and service body, a pool alarm, a water level detection system, and a prefilter for conveniently collecting and removing insects and other debris from the pool.

Numerous modifications may be made to this invention without departing from its scope as defined in the appended claims.

We claim:

1. A pool skimmer intake comprising:
a face plate sized and shaped to replace an existing face plate in a pool; and
a body having a back face formed with mounting elements for mounting said body on said face plate, an internal cavity housing sensors sensing conditions in the pool.

2. The pool skimmer inlet of claim 1 wherein said face plate and said body have matching opening defining a channel for fluid flow.

3. The pool skimmer of claim 1 wherein one of said face place and said body includes a rib and the other of said face place and said body includes a channel sized and shaped to support said body on said face plate.

4. The pool skimmer inlet of claim 3 wherein said rib and channel form an interference fit.

5. The pool skimmer inlet of claim 3 wherein said rib and channel are dovetailed together.

6. The pool skimmer inlet of claim 1 wherein said body includes a front face, further comprising indicators on said front face.

7. The pool skimmer inlet of claim 6 wherein said indicators include lights.

8. The pool skimmer inlet of claim 6 wherein said indicators include at least one audible alarm coupled to said circuitry to indicate an alarm condition.

9. The pool skimmer of claim 1 further comprising at least one cavity sized and shaped to receive a water level sensor.

10. The pool skimmer of claim 1 further comprising at least one cavity sized and shaped to receive a sensor adapted to sense when a large body falls into the pool.

11. The pool skimmer of claim 1 further comprising a mesh mounted on said body and arranged to filter water flowing through said body.
